(19) United States
(12) Patent Application Publication
(10) Pub. No.: US 2023/0124479 A1
(43) Pub. Date: Apr. 20, 2023

(54) METHOD OF MANUFACTURING AMORPHOUS SILICON COMPOSITE AND APPARATUS FOR MANUFACTURING AMORPHOUS SILICON COMPOSITE

(71) Applicant: KOREA METAL SILICON CO., LTD., Yeongwol-gun, Gangwon-do (KR)

(72) Inventors: Jong Oh CHOI, Yeongwol-gun, Gangwon-do (KR); Jong Sik YOO, Jungang-gu, Seoul (KR)

(21) Appl. No.: 17/907,190

(22) PCT Filed: Oct. 22, 2020
(86) PCT No.: PCT/KR2020/014454

§ 371 Date: Sep. 23, 2022

(30) Foreign Application Priority Data
Apr. 3, 2020 (KR) 10-2020-0041073

(51) Int. Cl. C01B 33/023; C09C 3/04; C09C 3/06

(52) U.S. Cl. CPC C01B 33/023; C09C 3/041; C09C 3/043; C09C 3/063; C01P 2002/02; C01P 2006/40; C01P 2004/80; B82Y 30/00

(57) ABSTRACT

Provided are a method of manufacturing an amorphous silicon composite and an apparatus for manufacturing an amorphous silicon composite. The method of manufacturing an amorphous silicon composite, according to an embodiment, may include forming molten silicon by melting a silicon raw material, obtaining an amorphous silicon powder by cooling the molten silicon with a cooling device such that the molten silicon is solidified before being crystallized, obtaining amorphous nano-silicon by performing wet grinding on the amorphous silicon powder, obtaining a first mixture by mixing a first pitch with the amorphous nano-silicon, obtaining a second mixture by coating a second pitch on the first mixture, and obtaining the amorphous silicon composite by performing heat treatment on the second mixture.

### TECHNICAL FIELD

The disclosure relates to a method of manufacturing an amorphous silicon composite and an apparatus for manufacturing an amorphous silicon composite.

### BACKGROUND ART

Graphite, a carbon-based material, is mainly used as an anode active material for a lithium secondary battery. However, graphite has a low lithium storage capacity (about 370 mAh/g), and thus, there is a limit for graphite to be used as an anode material for a lithium secondary battery having high capacity.

Accordingly, silicon, which has a relatively high lithium storage capacity (about 4200 mAh/g), is in the spotlight as a material that can replace graphite. However, because silicon has such high lithium storage capacity, silicon reacts with lithium during charging or discharging of a lithium secondary battery, and thus, a great change in volume of silicon occurs. As a result, damage, such as cracks or short circuits, may occur in the lithium secondary battery.

The above-mentioned background art is technical information that the inventor possesses for the purpose of derivation of the disclosure or obtains during the derivation of the disclosure, which is not necessarily a known technique disclosed to the general public prior to the filing of the disclosure.

### DESCRIPTION OF EMBODIMENTS

### Technical Problem

The disclosure provides a method of manufacturing an amorphous silicon composite capable of minimizing a change in volume thereof during use, and an apparatus for manufacturing an amorphous silicon composite. However, these problems are examples, and the scope of the disclosure is not limited thereto.

### Solution to Problem

A method of manufacturing an amorphous silicon composite, according to an embodiment, includes forming molten silicon by melting a silicon raw material, obtaining an amorphous silicon powder by cooling the molten silicon with a cooling device such that the molten silicon is solidified before being crystallized, obtaining amorphous nano-silicon by performing wet grinding on the amorphous silicon powder, obtaining a first mixture by mixing a first pitch with the amorphous nano-silicon, obtaining a second mixture by coating a second pitch on the first mixture, and obtaining the amorphous silicon composite by performing heat treatment on the second mixture.

In the method of manufacturing an amorphous silicon composite, according to an embodiment, the cooling device may include a body having an inlet portion at one end thereof through which the molten silicon is introduced, and an interior space in which the molten silicon moves in one direction, an outlet portion arranged on another end of the body, through which the molten silicon is discharged, and tapered in the one direction, and a plurality of spraying holes arranged in an outer peripheral surface of the body and spraying a cooling fluid into the interior space.

In the method of manufacturing an amorphous silicon composite, according to an embodiment, the plurality of spraying holes may be arranged in a plurality of spraying rows in a peripheral direction of the body, and respective spraying holes in neighboring spraying rows may be alternately arranged.

In the method of manufacturing an amorphous silicon composite, according to an embodiment, the plurality of spraying holes may have a spraying angle of 30° to 45° and a circular spraying shape, and arrangement angles formed by spraying holes adjacent to each other with the body may be different from each other.

In the method of manufacturing an amorphous silicon composite, according to an embodiment, the obtaining of the amorphous silicon powder may include cooling the molten silicon, separating the amorphous silicon powder with the cooling fluid by filtering the cooled molten silicon, and transferring the separated cooling fluid to the cooling device to spray the cooling fluid through the plurality of spraying holes.

In the method of manufacturing an amorphous silicon composite, according to an embodiment, in the obtaining of the amorphous silicon powder, a cooling rate may be 100 K/sec to 105 K/sec, and a moving speed of the molten silicon flowing through the interior space of the cooling device may be 0.9 L/min to 1.1 L/min.

In the method of manufacturing an amorphous silicon composite, according to an embodiment, the obtaining of the amorphous nano-silicon may include a primary wet grinding operation performed on the amorphous silicon powder, and a secondary wet grinding operation performed on the amorphous silicon powder on which the primary wet grinding operation has been performed, in the primary wet grinding operation, a grinding speed may be 1900 rpm to 2100 rpm, a bead diameter may be any one of 1 mm, 3 mm, and 5 mm, and a grinding time may be 0.5 hour to 1 hour, and in the secondary wet grinding operation, a grinding speed may be 2400 rpm to 2600 rpm, a bead diameter may be any one of 0.1 mm, 0.3 mm, 0.65 mm, and 0.8 mm, and a grinding time may be 1 hour to 1.5 hours.

In the method of manufacturing an amorphous silicon composite, according to an embodiment, the obtaining of the first mixture may include forming the first mixture by mixing the first pitch and distilled water in the amorphous nano-silicon, and spray-drying the first mixture.

In the method of manufacturing an amorphous silicon composite, according to an embodiment, the first mixture may be spray-dried by using a disc, a drying temperature may be 240° C. to 270° C., a rotation speed of the disc may be 5000 rpm to 10000 rpm, and in the first mixture after spray-drying, a content of the amorphous nano-silicon may be 60 weight % to 70 weight %, and a content of the first pitch may be 30 weight % to 40 weight %.

An apparatus for manufacturing an amorphous silicon composite, according to an embodiment, includes a melting furnace configured to form molten silicon by melting a silicon raw material, a cooling device configured to form an amorphous silicon powder by cooling the molten silicon, a wet grinding device configured to form amorphous nano-silicon by performing a wet grinding operation on the amorphous silicon powder, a mixing device configured to form a first mixture by mixing a first pitch with the amorphous nano-silicon, a spray-drying device configured to spray-dry the first mixture, a coating device configured to form a second mixture by coating a second pitch on the first mixture, and a heat-treatment device configured to form an amorphous silicon composite by performing heat treatment on the second mixture, wherein the cooling device includes a body having an inlet portion at one end thereof through which the molten silicon is introduced, and an interior space in which the molten silicon moves in one direction, an outlet portion arranged on another end of the body, through which the molten silicon is discharged, and tapered in the one direction, and a plurality of spraying holes arranged in an outer peripheral surface of the body and spraying a cooling fluid into the interior space, wherein the plurality of spraying holes are arranged in a plurality of spraying rows in a peripheral direction of the body, and respective spraying holes in neighboring spraying rows are alternately arranged in the one direction.

Other aspects, features, and advantages other than those described above will become apparent from the following detailed description, claims and drawings for carrying out the disclosure.

### Advantageous Effects of Disclosure

According to an embodiment, a method of manufacturing an amorphous silicon composite and an apparatus for manufacturing an amorphous silicon composite may minimize a change in volume of the amorphous silicon composite, and may improve the lifespan characteristics and capacity characteristics of a lithium secondary battery.

### BRIEF DESCRIPTION OF DRAWINGS

FIG. 1 is a diagram of an apparatus for manufacturing an amorphous silicon composite, according to an embodiment.

FIG. 2 is a diagram of a cooling device of FIG. 1.

FIGS. 3 to 5 are diagrams each illustrating an arrangement of spraying holes of the cooling device of FIG. 1.

FIG. 6 is a diagram illustrating a method of manufacturing an amorphous silicon composite, according to another embodiment.

### BEST MODE

A method of manufacturing an amorphous silicon composite, according to an embodiment, includes forming molten silicon by melting a silicon raw material, obtaining an amorphous silicon powder by cooling the molten silicon with a cooling device such that the molten silicon is solidified before being crystallized, obtaining amorphous nano-silicon by performing wet grinding on the amorphous silicon powder, obtaining a first mixture by mixing a first pitch with the amorphous nano-silicon, obtaining a second mixture by coating a second pitch on the first mixture, and obtaining the amorphous silicon composite by performing heat treatment on the second mixture.

### MODE OF DISCLOSURE

As the disclosure allows for various changes and numerous embodiments, particular embodiments will be illustrated in the drawings and described in detail in the written description. However, this is not intended to limit the disclosure to particular modes of practice, and it is to be appreciated that all changes, equivalents, and substitutes that do not depart from the spirit and technical scope are encompassed in the disclosure. In the description of the disclosure, like reference numerals in the drawings denote like elements even when illustrated in other embodiments.

While such terms as “first,” “second,” etc., may be used to describe various components, such components must not be limited to the above terms. The above terms are used only to distinguish one component from another.

The terms used in the disclosure are merely used to describe particular embodiments, and are not intended to limit the disclosure. In the disclosure, it is to be understood that the terms such as “including,” “having,” and “comprising” are intended to indicate the existence of the features, numbers, steps, actions, components, parts, or combinations thereof disclosed in the disclosure, and are not intended to preclude the possibility that one or more other features, numbers, steps, actions, components, parts, or combinations thereof may exist or may be added.

Hereinafter, the disclosure will be described more fully with reference to the accompanying drawings, in which embodiments of the disclosure are shown. For reference, unless otherwise specified in the disclosure, % may mean weight %.

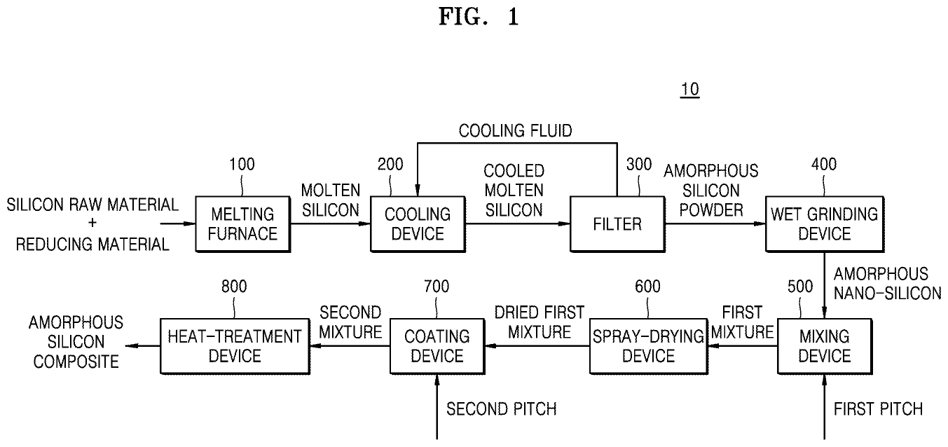

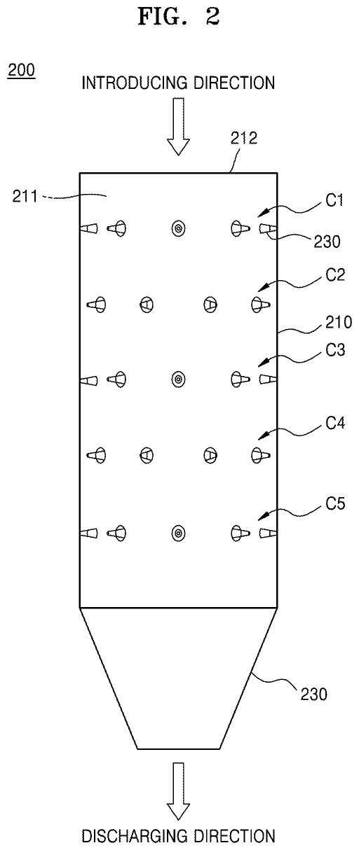

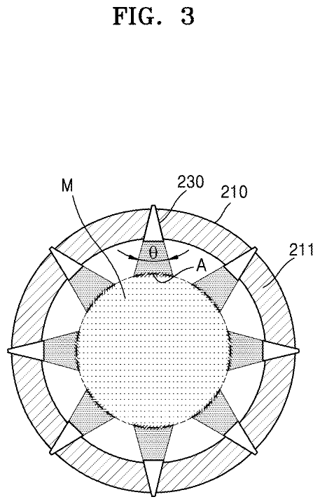

FIG. 1 is a diagram of an apparatus 10 for manufacturing an amorphous silicon composite, according to an embodiment, FIG. 2 is a diagram of a cooling device 200 of FIG. 1, and FIG. 3 is a diagram of an arrangement of spraying holes 230 of the cooling device 200 of FIG. 1.

Referring to FIG. 1, the apparatus 10 for manufacturing an amorphous silicon composite according to an embodiment may include a melting furnace 100, the cooling device 200, a filter 300, a wet grinding device 400, a mixing device 500, a spray-drying device 600, a coating device 700, and a heat-treatment device 800.

The melting furnace 100 is a device for forming molten silicon. When a silicon raw material is mixed with a reducing material, the silicon raw material and the reducing material being charged inside the melting furnace 100, the mixture of the silicon raw material and the reducing material is melted at a high temperature. As an embodiment, the melting furnace 100 may be an electric furnace. The melting furnace 100 may melt a silicon raw material and a reducing material at a temperature of 1800° C. or higher to form molten silicon.

The silicon raw material may be silicon dioxide (SiO₂) having high purity, and the reducing material may be a carbon-based material, such as charcoal, coke, or wood chips, for reducing the silicon raw material.

The cooling device 200 may rapidly cool molten silicon generated by the melting furnace 100 to form an amorphous silicon powder. The molten silicon formed in the melting furnace 100 is introduced into the cooling device 200 through a refractory container or the like.

The cooling device 200 may include a body 210, an outlet portion 220, and a spraying hole 230.

The body 210 is a member forming the frame of the cooling device 200, and includes an interior space 211 in which molten silicon introduced into the cooling device 200 flows. As an embodiment, the body 210 may have a hollow cylindrical shape. An inlet portion 212 through which molten silicon is introduced may be arranged on one side of the body 210. The molten silicon introduced into the inlet portion 212 may pass through the interior space 211 while flowing in one direction (for example, a lower portion of the cooling device 200 of FIG. 2), and may be cooled in this process.

The outlet portion 220 may be arranged on another side of the body 210. As an embodiment, the outlet portion 220 may have a tapered shaped in the one direction. Accordingly, the molten silicon passing through the interior space 211 may be discharged from the outlet portion 220 in a state of being collected.

Referring to FIG. 2, the cooling device 200 according to an embodiment may have at least one spraying hole 230 in the body 210. As an embodiment, a plurality of spraying holes 230 may be arranged on an outer peripheral surface of the body 210 to spray a cooling fluid into the interior space 211 of the cooling device 200.

The spraying hole 230 may be connected to a cooling fluid storage tank (not shown) through a metal connection pipe (not shown). A cooling fluid may be supplied from the cooling fluid storage tank through the connection pipe, and may be sprayed from the spraying hole 230.

The cooling fluid is not particularly limited, but water is preferably used for quick cooling and safety. Water may be sprayed through the spraying hole 230 to cool molten silicon flowing through the interior space 211 of the cooling device 200.

As an embodiment, the plurality of spraying holes 230 may be arranged in the outer peripheral surface of the body 210 in a plurality of spraying rows C. In more particular, as shown in FIG. 2, the plurality of spraying holes 230 may be arranged at set intervals in a peripheral direction of the body 210 to form the plurality of spraying rows C. Also, the plurality of spraying rows C may be arranged to be spaced apart from each other in a longitudinal direction of the body 210, that is, a flow direction of molten silicon.

FIG. 2 shows that the plurality of spraying holes 230 are arranged to form a first spraying row C1 to a fifth spraying row C5, but the number of spraying rows C is not particularly limited thereto.

As an embodiment, the spraying hole 230 included in each of the plurality of spraying rows C may be alternately arranged with the spraying hole 230 included in a neighboring spraying row C. In more particular, as shown in FIG. 2, respective spraying holes 230 included in the first spraying row C1 may be alternately arranged with respective spraying holes 230 included in the second spraying row C2, which is a neighboring spraying row C of the first spraying row C1. That is, the respective spraying holes 230 included in the first spraying row C1 may be arranged not to overlap the respective spraying holes 230 in the second spraying row C2 in the one direction.

Similarly, respective spraying holes 230 included in the second spraying row C2, the third spraying rows C3, the fourth spraying rows C4, and the fifth spraying row C5 may be alternately arranged with respective spraying holes 230 of a neighboring spraying row C thereof in the one direction.

Through such a configuration, a case in which the cooling fluid sprayed from respective spraying holes 230 is repeatedly sprayed on a surface of the molten silicon may be minimized, and thus, molten silicon may be efficiently and rapidly cooled. Accordingly, the time required for the cooling process may be shortened, and the tact time of the entire process may be shortened.

As an embodiment, when a virtual line extending the spraying holes 230 included in respective spraying rows C is drawn, the virtual line may be circular. That is, the spraying holes 230 included in respective spraying rows C may be arranged to have the same height on the outer peripheral surface of the body 210.

As another embodiment, the virtual line may be an ellipse. That is, the spraying holes 230 included in respective spraying rows C may be arranged to have different heights from each other on the outer peripheral surface of the body 210.

FIG. 2 illustrates that the spraying holes 230 included in the first spraying row C1, the third spraying row C3, and the fifth spraying row C5 are arranged side by side in the one direction, and the spraying holes 230 included in the second spraying row C2 and the fourth spraying row C4 are arranged side by side in the one direction, but the disclosure is not limited thereto. For example, arrangements of the spraying rows C and the spraying holes 230 in the spraying rows C may vary depending on the characteristics of the cooling device 200 and the molten silicon.

For example, the spraying holes 230 in respective spraying rows C may be alternately arranged with the spraying holes 230 in other spraying rows C, as well as the spraying holes 230 in a neighboring spraying row C. Through such a configuration, the cooling fluid may be prevented from being repeatedly sprayed on the surface of the molten silicon to efficiently and rapidly cool molten silicon.

As shown in FIG. 3, eight spraying holes 230 may be arranged at equal intervals (45°) in each of spraying rows C. However, the number of spraying holes 230 in the spraying row C and the angle between the spraying holes 230 are not limited thereto, and may vary depending on the cooling device 200 or the molten silicon.

FIG. 3 illustrates molten silicon as a region partitioned by a concentric circle inside the interior space 211, and a region where a cooling fluid is sprayed from the spraying hole 230 is indicated by hatching. In addition, an area in which the cooling fluid and the molten silicon are in contact, that is, an area (hereinafter, also referred to as a ‘cooling area A’) in which the molten silicon is cooled by the cooling fluid, is indicated by slashes.

As an embodiment, a spraying angle θ of a cooling fluid sprayed from the spraying hole 230 may be 30° to 45°. The spraying angle θ is an angle indicating a range in which the cooling fluid is sprayed from the spraying hole 230. When the spraying angle θ is less than 30°, an area to which the cooling fluid is sprayed is too narrow, and thus, making it difficult to completely cool the molten silicon.

On the other hand, when the spraying angle θ is greater than 45°, a spraying pressure of a cooling fluid is low, and the cooling efficiency is decreased.

As an embodiment, a spraying shape of a cooling fluid sprayed from the spraying hole 230 may be circular. Accordingly, an area in which the cooling fluid sprayed from the spraying hole 230 is in contact with the molten silicon may increase.

As an embodiment, the number of spraying holes 230 in the spraying row C and the spraying angle θ of the spraying hole 230 may be set such that the cooling fluids sprayed from respective spraying holes 230 do not overlap each other.

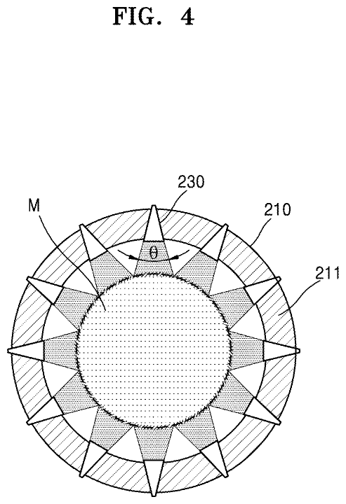

In more particular, as shown in FIG. 4, the number of spraying holes 230 in the spraying row C may be 12. In addition, the cooling areas A of respective spraying holes 230 may be formed not to overlap each other when the cooling device 200 is viewed from the top. That is, the cooling area A may be continuously arranged in a peripheral direction. Here, “substantially not overlapping” includes a case in which the cooling areas A do not overlap each other at all, or a case in which, even when the cooling areas A temporarily overlap each other according to a spraying state of a cooling fluid, an area in which the cooling areas overlap each other compared to the total area of the cooling areas A is negligibly small.

Through such a configuration, molten silicon may be uniformly and rapidly cooled, so that the cooling quality of the molten silicon may be improved, and the time required for the cooling process may be remarkably shortened.

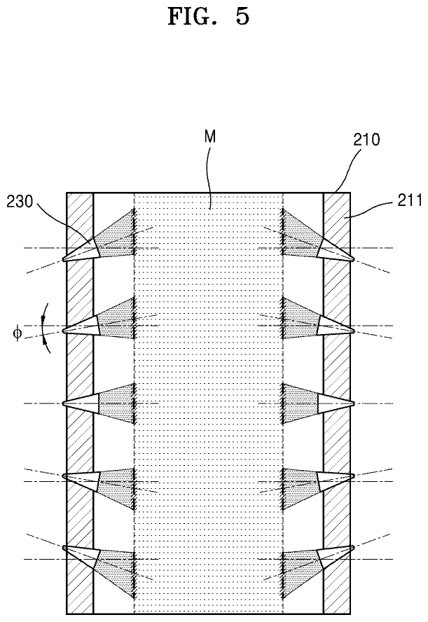

As an embodiment, the spraying hole 230 may be arranged to form a certain angle (hereinafter, also referred to as ‘arrangement angle (φ’) with the outer peripheral surface of the body 210. In more particular, as shown in FIG. 5, when the cooling device 200 is viewed from a side surface thereof, the spraying hole 230 may be arranged with respect to the outer peripheral surface of the body 210, may be arranged to be inclined upward with respect to the outer peripheral surface of the body 210, and may be arranged to be inclined downward with respect to the outer peripheral surface of the body 210.

The range of the arrangement angle φ of the spraying hole 230 is not particularly limited. As an embodiment, the arrangement angle φ between spraying holes 230 adjacent to each other in a peripheral direction and/or height direction of the body 210 may be different from each other.

Preferably, the arrangement angle φ of the spraying holes 230 may be set such that the cooling areas A caused by the spraying rows C adjacent to each other do not overlap each other in the one direction. Accordingly, molten silicon may be uniformly and rapidly cooled, so that the cooling quality of the molten silicon may be improved, and the time required for the cooling process may be shortened.

Accordingly, the cooling areas A do not overlap each other in a peripheral direction and/or height direction of the cooling device 200, and thus, the molten silicon may be uniformly and rapidly cooled.

FIG. 5 illustrates that five spraying rows C are arranged in the height direction of the body 210, but the disclosure is not limited thereto. As another embodiment, the cooling areas A formed by the spraying holes 230 included in the spraying rows C adjacent to each other may be formed not to substantially overlap each other in the height direction of the body 210. That is, the cooling areas A may be continuously arranged in the height direction of the body 210. Here, “substantially not overlapping” includes a case in which the cooling areas A do not overlap each other at all, or a case in which, even when the cooling areas A temporarily overlap each other according to a spraying state of a cooling fluid, an area in which the cooling areas overlap each other compared to the total area of the cooling areas A is negligibly small.

As described above, molten silicon that has passed through the cooling device 200 according to an embodiment may be rapidly cooled. In more particular, molten silicon according to the disclosure may be cooled at a faster rate than when left to cool at room temperature, and in particular, the molten silicon may be solidified before crystallization, and thus, an amorphous silicon powder may be obtained.

A rate at which silicon molten is cooled by the cooling device 200 may preferably be 100 K/sec to 105 K/sec. When a cooling rate is less than 100 K/sec, molten silicon is not cooled at a sufficiently fast rate, and thus, a crystalline silicon powder may be produced.

On the other hand, when the cooling rate exceeds 105 K/sec, the size of crystal grains of the formed amorphous silicon powder becomes too small. Accordingly, the hardness of the amorphous silicon powder is too high, and thus, a subsequent wet grinding operation takes a lot of time, and it is difficult to obtain amorphous nano-silicon having a desired particle size.

A speed at which molten silicon moves through the interior space 211 of the cooling device 200 may preferably be 0.9 L/min to 1.1 L/min. When a moving speed of molten silicon is less than 0.9 L/min, the size of crystal grains of a silicon powder may be small, and the hardness of the silicon powder may be excessively high.

On the other hand, when the moving speed of molten silicon M exceeds 1.1 L/min, cooling in the cooling device 200 is not performed properly, and thus, a silicon powder may not be obtained.

The pressure of a cooling fluid sprayed from the spraying hole 230 may preferably be 1 MPa to 1.5 MPa. When the spraying pressure of a cooling fluid is less than 1 MPa, cooling in the cooling device 200 is not performed properly, and thus, a silicon powder may not be obtained.

On the other hand, when the spraying pressure of a cooling fluid exceeds 1.5 MPa, filtering of an amorphous silicon powder and a cooling fluid in the filter 300 takes a lot of time, which may decrease production efficiency.

Through such a configuration, an amorphous silicon powder passing through the cooling device 200 may have a hardness (Mohs hardness) of 7.5 to 8. When the hardness of an amorphous silicon powder is less than 7.5, volume expansion may not be effectively suppressed when an amorphous silicon composite and a lithium secondary battery are manufactured using the amorphous silicon powder.

On the other hand, when the hardness of an amorphous silicon powder exceeds 8, a subsequent wet grinding operation takes a lot of time, and it is difficult to obtain amorphous nano-silicon having a desired particle size.

The filter 300 filters an amorphous silicon powder formed through the cooling device 200 and a cooling fluid. The filter 300 is arranged to be spaced apart from the outlet portion 220 of the cooling device 200, and a mixture in the form of a slurry in which an amorphous silicon powder and a cooling fluid are mixed is introduced. The type of the filter 300 is not particularly limited, and it is sufficient as long as an amorphous silicon powder may be separated from a cooling fluid.

A filtered amorphous silicon powder is introduced into the wet grinding device 400. A wet grinding device in the related art may be used as the wet grinding device 400. Distilled water, ethanol, or isopropyl alcohol (IPA) may be used as a solvent used in the wet grinding device 400, and, preferably, distilled water may be used.

As an embodiment, the wet grinding device 400 according to the disclosure may perform wet grinding on an amorphous silicon powder in two operations.

The diameter of a bead used in a primary wet grinding operation is preferably 1 mm, 3 mm, and 5 mm, and more preferably is 1 mm. A grinding speed in the primary wet grinding operation is preferably 1900 rpm to 2100 rpm, and more preferably is 2000 rpm to 2100 rpm. A grinding time in the primary wet grinding operation may be 0.5 hour to 1.0 hour.

A median particle size (D50) of amorphous nano-silicon ground in the primary wet grinding operation may be 1 μm.

Next, the wet grinding device 400 performs a secondary wet grinding operation on the amorphous nano-silicon ground in the primary wet grinding operation.

The diameter of a bead used in the secondary wet grinding operation is preferably 0.1 mm, 0.3 mm, 0.65 mm, and 0.8 mm, and more preferably is 0.1 mm. A grinding speed in the secondary wet grinding operation may be 2400 rpm to 2600 rpm, and more preferably be 2500 rpm to 2600 rpm. A grinding time in the secondary wet grinding operation may be 1.0 hour to 1.5 hours.

A median particle size of amorphous nano-silicon obtained in the secondary wet grinding operation may be 300 nm.

In this way, the wet grinding device 400 according to an embodiment may perform a wet grinding process having two operations having different process conditions to perform a rough process in the primary wet grinding operation and to perform a finish process in the secondary wet grinding operation.

In more particular, in the first wet grinding operation as the rough process, wet grinding may be performed by using a bead having a relatively large diameter to manufacture amorphous nano-silicon having a median particle size of 1 μm or less. Next, in the secondary wet grinding operation as the finish process, wet grinding may be performed by using a bead having a relatively small diameter to manufacture amorphous nano-silicon having a median particle of 300 nm or less.

Accordingly, the wet grinding device 400 according to the disclosure may minimize oxidation of an amorphous silicon powder by completing a wet grinding operation within a short time. In addition, the wet grinding device 400 according to the disclosure may easily obtain amorphous nano-silicon having a median particle size of 300 nm or less without using expensive plasma equipment.

Referring back to FIG. 1, a filtered cooling fluid may be stored in a separate storage tank (not shown) and supplied back to the cooling device 200 through a transfer device (not shown). That is, the cooling fluid sprayed once through the cooling device 200 may be used again through the filter 300.

The mixing device 500 may mix a first pitch with the amorphous nano-silicon ground by the wet grinding device 400 to form a first mixture. As an embodiment, the mixing device 500 may be a wet mixing device, and distilled water may be used as a solvent.

As an embodiment, the first mixture may include only the amorphous nano-silicon, the first pitch, and a solvent. That is, unlike other silicon composites, the first mixture according to the disclosure may not include a carbon material or binder, an organic solvent, or the like, other than the first pitch.

The first pitch is then dried and cured by heat of the spray-drying device 600, and accordingly, expansion of an amorphous silicon composite may be suppressed.

The spray-drying device 600 performs a spray-drying operation on the first mixture formed in the mixing device 500 to evaporate the solvent contained in the first mixture. As an embodiment, the spray-drying device 600 may rotate a disc at high speed and spray the first mixture to dry the first mixture.

A spray-drying temperature may preferably be 240° C. to 270° C. When the spray-drying temperature is less than 240° C., the fluidity of the first pitch is lowered, and thus, the amorphous nano-silicon and the first pitch are not uniformly mixed with each other, and the first mixture may not be sufficiently made spherical.

On the other hand, when the spray-drying temperature exceeds 270° C., the fluidity of the first pitch is too high, and thus, the amorphous nano-silicon and the first pitch may not be mixed with each other, and the first pitch may be separated from the amorphous nano-silicon.

The fluidity of the first pitch may be optimized at the spray-drying temperature as described above, and the amorphous nano-silicon and the first pitch may be uniformly mixed with each other. Accordingly, as described above, the mixing device 500 and the spray-drying device 600 according the disclosure may control the fluidity of the first pitch without using a separate binder to obtain the first mixture in which the amorphous nano-silicon and the first pitch are uniformly mixed with each other.

A rotation speed of the disc of the spray-drying device 600 may preferably be 5000 rpm to 10000 rpm. When the rotation speed of the disc is less than 5000 rpm, the rotation speed is too low, and thus, a first mixture having a relatively large particle size of 10 μm to 20 μm in average particle size may be recovered.

On the other hand, when the rotation speed of the disc exceeds 10000 rpm, the rotation speed is too fast, and the amorphous nano-silicon and the first pitch are separated from each other, and thus, the first mixture may not be properly manufactured.

The average particle size of a preferred first mixture obtained in the temperature range and the rotation speed range may be 3 μm to 5 μm.

As an embodiment, in the first mixture in which the solvent is evaporated by the spray-drying device 600, the weight % of the amorphous nano-silicon may be 60 to 70, and the weight % of the first pitch may be 30 to 40. That is, after spray-drying, the first mixture may only include amorphous nano-silicon and the first pitch.

When the content of the amorphous nano-silicon is less than 60 weight %, the capacity of the amorphous silicon composite may be lowered. On the other hand, when the content of the amorphous nano-silicon exceeds 70 weight %, it is difficult to suppress the volume expansion of an amorphous silicon composite.

The coating device 700 coats a second pitch on the first mixture dried by the spray-drying device 600 to form a second mixture. The coating device 700 is not particularly limited, and equipment, such as mechanofusion or a ball mill, may be used. The second pitch is coated on the surface of the first mixture, which is spheroidized, and thereafter, the expansion of the amorphous silicon composite may be suppressed.

The heat-treatment device 800 performs heat treatment on the second mixture obtained from the coating device 700. As an embodiment, the heat-treatment temperature of the heat-treatment device 800 may be 800° C. or more and less than 1000° C. More preferably, the heat-treatment temperature may be 800° C. or more and 900° C. or less.

When the heat-treatment temperature is less than 800° C., a sufficient bonding strength between the amorphous nano-silicon contained in the second mixture, the first pitch, and the second pitch may not be secured.

On the other hand, when the heat-treatment temperature is 1000° C. or higher, amorphous nano-silicon may be crystallized.

Hereinafter, a method of manufacturing an amorphous silicon composite, according to another embodiment, is described with reference to FIGS. 1 to 6.

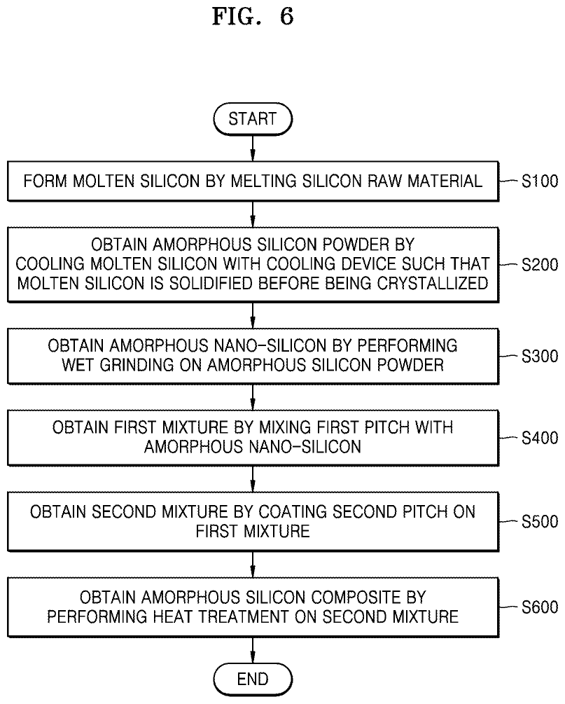

FIG. 6 is a diagram illustrating a method of manufacturing an amorphous silicon composite, according to another embodiment.

First, a silicon raw material is melted to form molten silicon (S100). After the silicon raw material and a reducing material are charged into the melting furnace 100 and are mixed, the mixture of the silicon raw material and the reducing material is then melted by heating using the melting furnace 100. The temperature of the melting furnace 100 may be 1800° C. or higher.

Next, an amorphous silicon powder is obtained by cooling the molten silicon (S200). The molten silicon is rapidly cooled by the cooling device 200 such that the molten silicon is solidified before being crystallized. Accordingly, the molten silicon may be made into an amorphous silicon powder.

As an embodiment, the obtaining of an amorphous silicon powder (3200) may include cooling the molten silicon (S210), separating the amorphous silicon powder from the cooling fluid by filtering the cooled molten silicon (S220), and transferring the separated cooling fluid to a cooling device to spray the cooling fluid through a spraying hole (S230).

In the cooling of the molten silicon (S210), the molten silicon may be rapidly cooled by the cooling device 200. The cooling device 200 may have the same configuration as the above-described configuration, and accordingly, a case in which the spraying fluids sprayed from respective spraying holes 230 are repeatedly sprayed on the surface of the molten silicon may be minimized, and thus, the molten silicon may be efficiently and rapidly cooled. Also, the time required for a cooling process may be shortened, and thus, the tact time of the entire process may be shortened.

In the cooling of the molten silicon (S210), a cooling rate may preferably be 100 K/sec to 105 K/sec. In the cooling of the molten silicon (S210), a moving speed of the molten silicon may preferably be 0.9 L/min to 1.1 L/min. In the cooling of the molten silicon (S210), a spraying pressure of the cooling fluid may preferably be 1 MPa to 1.5 MPa. In addition, the amorphous silicon powder obtained in the cooling of the molten silicon (S210) may have a hardness of 7.5 to 8 in terms of Mohs hardness.

Next, the molten silicon cooled through the filter 300 is separated into an amorphous silicon powder and a cooling fluid (S220).

Then, the separated cooling fluid is stored in a storage tank (not shown) and then transferred to the cooling device 200 through a transfer device (not shown) to be sprayed into the interior space 211 of the cooling device 200 through the spraying hole 230. That is, the cooling fluid used in the cooling process may be filtered and used again.

Next, wet grinding is performed on the amorphous silicon powder to obtain amorphous nano-silicon (S300). The wet grinding may be performed by the wet grinding device 400.

As an embodiment, the obtaining of the amorphous nano-silicon may include a primary wet grinding operation on the amorphous silicon powder (3310) and a secondary wet grinding operation on the amorphous silicon powder on which the primary wet grinding operation has been performed (S320).

The diameter of a bead used in the primary wet grinding operation (S310) may preferably be 1 mm, 3 mm, and 5 mm, and more preferably be 1 mm. A grinding speed in the primary wet grinding operation (S310) may preferably be 1900 rpm to 2100 rpm, and more preferably be 2000 rpm to 2100 rpm. A grinding time in the primary wet grinding operation (3310) may be 0.5 hour to 1.0 hour.

Accordingly, the median particle size (D50) of the amorphous nano-silicon obtained in the primary wet grinding operation (3310) may be 1 μm.

Next, the diameter of a bead used in the secondary wet grinding operation (S320) may preferably be 0.1 mm, 0.3 mm, 0.65 mm, and 0.8 mm, and more preferably be 0.1 mm. A grinding speed in the secondary wet grinding operation (S320) may be 2400 rpm to 2600 rpm, and more preferably be 2500 rpm to 2600 rpm. A grinding time in the secondary wet grinding operation (S320) may be 1.0 hour to 1.5 hour.

Accordingly, the median particle size of the amorphous nano-silicon obtained in the secondary wet grinding operation (S320) may be 300 nm.

In more particular, Table 1 below shows the particle size distribution of the amorphous nano-silicon obtained in the obtaining of the amorphous nano-silicon (S300) according to an embodiment.

TABLE 1

| | | Particle size of amorphous nano-silicon | | | |
|---|---|---|---|---|---|
| | | (μm) | | | |
| | Particle size of | Wet grinding | | | |
| | amorphous | (First | Wet grinding (Second operation) | | |
| | silicon | operation) | 30 | 60 | 90 |
| | powder (μm) | 30 minutes | minutes | minutes | minutes |
| D10 | 3.382 | 0.716 | 0.376 | 0.268 | 0.157 |
| D50 | 15.250 | 1.036 | 0.593 | 0.370 | 0.258 |
| D90 | 54.702 | 2.941 | 1.791 | 1.018 | 0.617 |

In Table 1, the amorphous silicon powder represents the amorphous silicon powder after passing through the filter 300 and before the wet grinding process. As shown in Table 1, when conditions of the wet grinding process according to the disclosure are satisfied, amorphous nano-silicon having a median particle size of 300 nm or less may be obtained, and oxidation of the amorphous silicon powder may be minimized by completing the wet grinding process within a short time. Next, a first pitch is mixed with the amorphous nano-silicon to obtain a first mixture (S400). As an embodiment, the obtaining of the first mixture may be a wet mixing process in which distilled water is used as a solvent. In addition, the obtaining of the first mixture may include mixing the first pitch and distilled water in the amorphous nano-silicon to form a first mixture (S410), and spray-drying the first mixture (S420).

The forming of the first mixture (S410) may be performed by mixing the first pitch with the amorphous nano-silicon, and mixing distilled water as a solvent. In more particular, the forming of the first mixture (3410) may not use a carbon-based material, a binder, or an organic solvent, other than the first pitch. Accordingly, the first mixture prepared may include only the amorphous nano-silicon, the first pitch, and distilled water.

Next, the first mixture formed is spray-dried (S420). The spray-drying process may be performed by using the spray-drying device 600.

A spray-drying temperature may preferably be 240° C. to 270° C. In addition, a rotation speed of a disc used in the spray-drying process may preferably be 5000 rpm to 10000 rpm. The average particle size of a preferred first mixture obtained in the temperature range and the rotation speed range may be 3 μm to 5 μm.

The first mixture subjected to the spray-drying process may include only the amorphous nano-silicon and the first pitch by evaporation of the solvent. In the first mixture, the content of the amorphous nano-silicon may be 60 to 70 weight %, and the content of the first pitch may be 30 to 40 weight %.

Next, a second mixture is obtained by coating a second pitch on the first mixture (S500). The coating process may be performed by using the coating device 700. The second mixture is formed by coating the second pitch on the first mixture, which is dried.

Next, an amorphous silicon composite is obtained by performing heat treatment on the second mixture. The heat treatment process may be performed by using the heat-treatment device 800, and a preferred heat treatment temperature may be 800° C. or more and less than 1000° C. More preferably, the heat treatment temperature may be 800° C. or more and 900° C. or less.

TABLE 2

| | Medium particle | | | |
|---|---|---|---|---|
| | size of | Charging | Discharging | Efficiency |
| | nano-silicon | capacity | capacity | (discharge/ |
| | (nm) | (mAh/g) | (mAh/g) | charge, %) |
| Comparative | 150 | 3625 | 1357 | 37.3 |
| example | 300 | 3641 | 1737 | 47.7 |
| Embodiment | 150 | 3580 | 2332 | 65.2 |
| | 300 | 3781 | 2726 | 72.1 |

Table 2 shows the capacity characteristics and efficiency characteristics (one-time charge/discharge test) of a lithium secondary battery (embodiment) manufactured using amorphous nano-silicon manufactured by the method of manufacturing amorphous silicon according to an embodiment, and a lithium secondary battery (comparative example) manufactured using crystalline nano-silicon in the related art.

As shown in Table 2, in the case of the lithium secondary battery using crystalline nano-silicon, a reaction between silicon and lithium occurs as an irreversible reaction during charging and discharging of the battery. Silicon and lithium bonded to each other exist as a silicon-lithium compound without being separated again. The silicon-lithium compound does not function as an anode active material in a lithium secondary battery.

Also, silicon may theoretically bond with 4.4 lithium atoms per atom. Accordingly, the volume of silicon is increased, and in this process, silicon is separated from a current collector to generate an irreversible material, and thus, the silicon does not function as an anode active material.

On the other hand, in the case of a lithium secondary battery using amorphous nano-silicon, it may be seen that the efficiency thereof is significantly higher than that of the comparative example in any case. In particular, when the median particle size of the amorphous silicon was 300 nm, it was found that the charge capacity, the discharge capacity, and the efficiency were all excellent.

As described above, in the case of the amorphous nano-silicon according to the disclosure, this is because volume expansion of silicon may be effectively suppressed as the amorphous nano-silicon has a greater hardness than crystalline nano-silicon in the related art by being manufactured through a manufacturing method that satisfies preset conditions.

The method of manufacturing an amorphous silicon composite and the apparatus 10 for manufacturing an amorphous silicon composite according to an embodiment may manufacture an amorphous silicon composite based on an amorphous silicon powder having a certain hardness. Accordingly, when the amorphous silicon composite according to an embodiment is used as an anode active material for a lithium secondary battery, damage to the lithium secondary battery may be reduced, and a lithium secondary battery having excellent capacity characteristics and lifespan characteristics may be provided.

### EXPLANATION OF REFERENCE NUMERALS DESIGNATING THE MAJOR ELEMENTS OF THE DRAWINGS

10: apparatus for manufacturing an amorphous silicon composite
100: melting furnace
200: cooling device
300: filter
400: wet grinding device
500: mixing device
600: spray-drying device
700: coating device
800: heat-treatment device

### INDUSTRIAL APPLICABILITY

According to an embodiment, a method of manufacturing an amorphous silicon composite and an apparatus for manufacturing an amorphous silicon composite minimize a change in volume of the amorphous silicon composite, and improves the lifespan characteristics and capacity characteristics of a lithium secondary battery, thereby being able to be used in related industrial fields.

1. A method of manufacturing an amorphous silicon composite, the method comprising:
forming molten silicon by melting a silicon raw material;
obtaining an amorphous silicon powder by cooling the molten silicon with a cooling device such that the molten silicon is solidified before being crystallized;
obtaining amorphous nano-silicon by performing wet grinding on the amorphous silicon powder;
obtaining a first mixture by mixing a first pitch with the amorphous nano-silicon;
obtaining a second mixture by coating a second pitch on the first mixture; and
obtaining the amorphous silicon composite by performing heat treatment on the second mixture.

2. The method of claim 1, wherein the cooling device comprises:
a body having an inlet portion at one end thereof through which the molten silicon is introduced, and an interior space in which the molten silicon moves in one direction;
an outlet portion arranged on another end of the body, through which the molten silicon is discharged, and tapered in the one direction; and
a plurality of spraying holes arranged in an outer peripheral surface of the body and spraying a cooling fluid into the interior space.

3. The method of claim 2, wherein the plurality of spraying holes are arranged in a plurality of spraying rows in a peripheral direction of the body, and respective spraying holes in neighboring spraying rows are alternately arranged.

4. The method of claim 2, wherein the plurality of spraying holes have a spraying angle of 30° to 45° and a circular spraying shape, and arrangement angles formed by spraying holes adjacent to each other with the body are different from each other.

5. The method of claim 2, wherein the obtaining of the amorphous silicon powder comprises:
cooling the molten silicon;
separating the amorphous silicon powder with the cooling fluid by filtering the cooled molten silicon; and
transferring the separated cooling fluid to the cooling device to spray the cooling fluid through the plurality of spraying holes.

6. The method of claim 1, wherein, in the obtaining of the amorphous silicon powder, a cooling rate is 100 K/sec to 105 K/sec, and
a moving speed of the molten silicon flowing through the interior space of the cooling device is 0.9 L/min to 1.1 L/min.

7. The method of claim 1, wherein the obtaining of the amorphous nano-silicon comprises:
a primary wet grinding operation performed on the amorphous silicon powder; and
a secondary wet grinding operation performed on the amorphous silicon powder on which the primary wet grinding operation has been performed,
wherein, in the primary wet grinding operation,
a grinding speed is 1900 rpm to 2100 rpm, a bead diameter is any one of 1 mm, 3 mm, and 5 mm, and a grinding time is 0.5 hour to 1 hour, and,
in the secondary wet grinding operation,
a grinding speed is 2400 rpm to 2600 rpm, a bead diameter is any one of 0.1 mm, 0.3 mm, 0.65 mm, and 0.8 mm, and a grinding time is 1 hour to 1.5 hours.

8. The method of claim 1, wherein the obtaining of the first mixture comprises:
forming the first mixture by mixing the first pitch and distilled water in the amorphous nano-silicon; and
spray-drying the first mixture.

9. The method of claim 8, wherein, in the spray-drying of the first mixture, the first mixture is spray-dried by using a disc, a drying temperature is 240° C. to 270° C., a rotation speed of the disc is 5000 rpm to 10000 rpm, and
in the first mixture after spray-drying, a content of the amorphous nano-silicon is 60 weight % to 70 weight %, and a content of the first pitch is 30 weight % to 40 weight %.

10. An apparatus for manufacturing an amorphous silicon composite, the apparatus comprising:
a melting furnace configured to form molten silicon by melting a silicon raw material;
a cooling device configured to form an amorphous silicon powder by cooling the molten silicon;
a wet grinding device configured to form amorphous nano-silicon by performing a wet grinding operation on the amorphous silicon powder;
a mixing device configured to form a first mixture by mixing a first pitch with the amorphous nano-silicon;
a spray-drying device configured to spray-dry the first mixture;
a coating device configured to form a second mixture by coating a second pitch on the first mixture; and
a heat-treatment device configured to form an amorphous silicon composite by performing heat treatment on the second mixture,
wherein the cooling device comprises:
a body having an inlet portion at one end thereof through which the molten silicon is introduced, and an interior space in which the molten silicon moves in one direction;
an outlet portion arranged on another end of the body, through which the molten silicon is discharged, and tapered in the one direction; and
a plurality of spraying holes arranged in an outer peripheral surface of the body and spraying a cooling fluid into the interior space,
the plurality of spraying holes are arranged in a plurality of spraying rows in a peripheral direction of the body, and respective spraying holes in neighboring spraying rows are alternately arranged in the one direction.
